(19) United States
(12) Patent Application Publication
(10) Pub. No.: US 2026/0268524 A1
(43) Pub. Date: Sep. 10, 2026

(54) PARAMETER GENERATION FOR SENSOR CALIBRATION

(71) Applicant: NVIDIA Corporation, Santa Clara, CA (US)

(72) Inventors: Joonhwa Shin, Santa Clara, CA (US); Donghyun Yoo, Fairfax, VA (US); Hugo Maxence Verjus, Zurich (CH)

(21) Appl. No.: 19/072,646

(22) Filed: Mar. 6, 2025

(51) Int. Cl. G06T 7/80; G06T 7/11; G06T 7/70; G06V 10/25

(52) U.S. Cl. CPC G06T 7/80; G06T 7/11; G06T 7/70; G06V 10/25; G06V 2201/07

(57) ABSTRACT

In various examples, systems and methods are provided for parameter generation for sensor calibration. A dataset of samples bounding shape(s) may be established from detection bounding shape(s) corresponding to object(s) detected in image(s) represented by sensor data captured by a sensor. A parameter space may be searched for estimated calibration parameters for the sensor using an optimization process. The optimization process may include iteratively generating sets of candidate calibration parameters for the sensor based at least on a difference between sets of candidate bounding shapes generated from the sets of candidate calibration parameters and the sampled bounding shape(s). The optimization process may include outputting the estimated calibration parameters for the sensor in response to a difference between a set of candidate bounding shapes corresponding to the estimated calibration parameters for the sensor and the sampled bounding shape(s) satisfying a first threshold and/or level of convergence.

### BACKGROUND

Many vision applications (e.g., three-dimensional (3D) location estimation, depth estimation, object pose estimation, augmented reality, etc.) rely on precisely calibrated sensors to function properly. Parameters that influence sensor calibration (e.g., with respect to how a 3D space is captured as a two-dimensional (2D) image) may include both extrinsic and intrinsic parameters. Extrinsic parameters may refer to factors that describe the physical orientation of the sensor, such as rotation and translation (also referred to as roll and tilt) and/or other parameters. Intrinsic parameters may refer to factors that describe sensor optics, such as optical center (also known as the principal point), focal length, skew coefficient, field of view or sensory field, and/or other parameters. The extrinsic and intrinsic parameters of a sensor both play a part in how features of a scene within a 3D world coordinate space (which may be referred to as the world coordinate system) are mapped to the 2D coordinate space of the plane of a sensor captured image. While the intrinsic parameters of a sensor may be established during manufacture and may be expected to remain reasonably stable, the extrinsic parameters of rotation and translation may change or fluctuate over time depending on how the sensor is mounted and oriented within a particular space.

### SUMMARY

Embodiments of the present disclosure relate to parameter generation for sensor calibration. Systems and methods are disclosed that may be used for, among other things, calibrating image sensors using image data captured after deployment during normal operation of the image sensors.

In contrast to conventional systems, such as those described above, the systems and methods presented in this disclosure estimate calibration parameters for one or more sensors based on objects detected in one or more images represented by sensor data captured during normal operation of the sensor(s) (e.g., after deployment). A set of calibration parameters for the sensor(s) may be estimated using an optimization process that iteratively attempts to match detection bounding shapes corresponding to detected objects and candidate bounding shapes generated based on models of the detected objects that are projected based on candidate calibration parameters to the images. In some embodiments, preprocessing techniques may be used to filter the detection bounding shapes and remove outliers (e.g., resulting from an object being occluded, partially visible, or abnormally sized) that may bias the estimation of the calibration parameters using the optimization process. The optimization may iteratively refine the candidate calibration parameters until a similarity metric between the detection bounding shapes and candidate bounding shapes satisfies a threshold and/or converges. The techniques described herein enable remote calibration of sensors and are scalable to a large number of sensors.

### BRIEF DESCRIPTION OF THE DRAWINGS

The present systems and methods for parameter generation for sensor calibration are described in detail below with reference to the attached drawing figures, wherein:

FIG. 1 is an illustration of an example flow diagram for a calibration parameter generation operating environment suitable for use in implementing some embodiments of the present disclosure;

FIG. 2 is an example image with a detection bounding shape and candidate bounding shape suitable for use in implementing some embodiments of the present disclosure;

FIG. 3 is an illustration of an example flow diagram for sensor calibration parameter generation, in accordance with some embodiments of the present disclosure;

FIG. 4 is an illustration of an example flow diagram for establishing a dataset of sampled bounding shapes, in accordance with some embodiments of the present disclosure;

FIG. 5 is an illustration of an example flow diagram for generating calibration parameters for a sensor, in accordance with some embodiments of the present disclosure;

FIG. 6 is an illustration of an example flow diagram for sensor calibration parameter generation, in accordance with some embodiments of the present disclosure;

FIG. 7 is an illustration of an example flow diagram for lens distortion calibration parameter generation, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to parameter generation for sensor calibration. During calibration for a sensor that captures sensor data that may be used to generate 2D images (e.g., a camera), a 3×4 projection matrix may be determined that projects a 3D point in a coordinate system (e.g., the world coordinate system) to a 2D point in a 2D image. The relationship between a sensor's 2D coordinate space (u, v) and the 3D world coordinate space (X_{w}, Y_{w}, Z_{w}) may be expressed as:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z}\end{matrix} ] [ \begin{matrix}{X}_{w} \\ {Y}_{w} \\ {Z}_{w} \\ 1\end{matrix} ]$$

where the sensor intrinsic parameters fₓ and f_{y} correspond to focal length, cₓ and c_{y} correspond to the sensor principal point, and s is a scaling factor. Regarding the sensor extrinsic parameters, these are expressed by the rotation-translation (RT) matrix wherein the rotation vector (R) comprises the elements r₁₁, r₂₁, r₃₁, r₁₂, r₂₂, r₃₂, r₁₃, r₂₃, r₃₃ of the RT matrix, and the translation vector (T) comprises the elements tₓ, t_{y}, t_{z} of the RT matrix.

Traditionally, sensor calibration techniques include various manual processes. Prior factory procedures for calibrating sensors involve the use of an artificial planar calibration pattern board (e.g., a chessboard pattern) that is manually placed within the frame of the sensor in different positions and poses. Computation of the sensor rotation and translation parameters is then performed based on evaluating a series of images of the calibration board in the different positions and poses as captured by the sensor. However, this process may not be performable by consumers after installation of the sensor to account for drifting sensor rotation and translation parameters over time. For example, if a sensor is installed in a location that is not easy to reach (e.g., near the ceiling of a tall room), is inaccessible (e.g., in a restricted access area), or has a large field of view, a consumer may not be able to perform these manual techniques. Further, these manual techniques are time consuming and labor intensive such that they are not scalable for calibrating a large number of sensors deployed in a large physical space (e.g., airport, factory, warehouse, retail store, etc.).

Some techniques for automating calibration of a large number of sensors utilize tools that may allow human operators to select a correspondence between the 2D image view and a 3D plane (e.g., floor map). These techniques may involve using existing camera calibration tools that support homography matrix estimation that provides for 2D-to-2D mapping (e.g., ground plane to camera image plane). While these techniques reduce the time for sensor calibration compared to using the artificial planar calibration pattern board, they do not provide a solution for automating calibration of full 3D-to-2D mapping between the world coordinate system and the 2D sensor coordinate system.

In contrast to conventional systems, such as those described above, the systems and methods presented in this disclosure may estimate calibration parameters for one or more sensors based on objects detected in one or more images represented by sensor data captured during normal operation of the sensor(s). A sensor parameter space (e.g., defined by the range of each sensor parameter) may be searched for a set of calibration parameters for the sensor(s) using an optimization process that attempts to match detection bounding shapes (e.g., boxes) and candidate bounding shapes (e.g., boxes) generated based on projected models of the detected objects in the images. In some embodiments, preprocessing techniques may be used to filter the detection bounding shapes and remove outliers (e.g., resulting from an object being occluded, partially visible, or abnormally sized) that may bias the estimation of the calibration parameters. By using the techniques described herein, human operators are not required to be on site to generate the sensor data or images, and objects at the site may be used for calibration rather than the artificial planar calibration pattern boards. The techniques described herein enable remote calibration of sensors and are scalable to a large number of sensors.

A sensor to be calibrated may be an RGB sensor, infrared (IR) sensor, depth sensor, camera, and/or other optical sensor and may capture sensor data (e.g., representing 2D images). Objects (e.g., humans, vehicles, robots, etc.) may be detected in the sensor data using one or more object detection models (e.g., PeopleNet, SyntheticaDETR, etc.), and detection bounding shapes may be generated that correspond to objects detected in the one or more images. In some embodiments, the detection bounding shapes are detection bounding boxes and may serve as ground truth data for the optimization process described herein.

A dataset of sampled bounding shapes may be established from the detection bounding shapes. In some embodiments, the dataset of sampled bounding shapes may include a set of the detection bounding shapes from one or more 2D images. If detection bounding shapes are generated for multiple 2D images, then the detection bounding shapes for the 2D images may be accumulated into a single image. For example, if two images are captured by a sensor and each image includes two detection bounding shapes, then the single image would include four detection bounding shapes after accumulating the detection bounding shapes. The detection bounding shapes may correspond to a single object that is detected in multiple images or multiple objects that are detected in one or more images.

In some embodiments, the dataset of sampled bounding shapes may include a set of the detection bounding shapes without any preprocessing or filtering. However, the dimensions of the detection bounding shapes may vary depending on a number of factors including, but not limited to, the size of the corresponding object, the proximity of the corresponding object to the sensor, the pose of the object, and whether the corresponding object is occluded. The result of the calibration parameter estimation may be biased if outlier detection bounding shapes (e.g., corresponding to an object that is occluded, abnormally sized, or in an abnormal pose) are used during the optimization process discussed herein. In order to remove outlier detection bounding shapes that may bias the calibration parameter estimation, the detection bounding shapes may be filtered using one or more preprocessing techniques to establish the dataset of sampled bounding shapes. The preprocessing techniques may be performed for the detection bounding shapes prior to accumulation (e.g., on an image-by-image basis) or after accumulation. The preprocessing techniques may be used to remove detection bounding shapes from further use and/or to select particular detection bounding shapes to be used in the optimization process described herein.

The preprocessing techniques may include removing detection bounding shapes that touch an outer boundary/border of the image. In some embodiments, the preprocessing techniques may include fitting a characteristic (e.g., height, width, aspect ratio) of the detection bounding shapes to a curve (e.g., polynomial curve) and removing detection bounding shapes that are more than a threshold distance from the curve. For example, separate curves may be used for fitting height, width, and aspect ratio, and a detection bounding shape may be removed if its height, width, or aspect ratio are more than a threshold distance away from the respective curves.

The image (or images, if applicable) may also be divided into regions, which may form a grid (e.g., 3×3, 4×4, 5×5, etc.). After the image is divided into regions, each of the detection bounding shapes may be assigned to a respective region. In some embodiments, the detection bounding shapes are assigned to a region based on which region a center point or center coordinate of the bounding shape is located within. Once the detection bounding shapes are assigned to a region, all but one of the detection bounding shapes for each region (that includes any detection bounding shapes) may be removed such that a single detection bounding shape remains per region. In other words, for the regions that include one or more detection bounding shapes assigned to them, a single one of those detection bounding shapes may be selected for use in the optimization process discussed herein. The selection of the particular detection bounding shapes may be determined, for example, based on the detection bounding shape that has a median size for the region. The detection bounding shapes that are selected may form the dataset of the sampled bounding shapes.

Based at least on the dataset of the sampled bounding shapes is established, a parameter space may be searched for a set of calibration parameters for the sensor using an optimization process (e.g., a Bayesian or black-box optimization process). The set of calibration parameters may include intrinsic parameters (e.g., focal length and principal point) and/or extrinsic parameters (e.g., rotation and translation) for the sensor. In some embodiments, the set of calibration parameters for the sensor may comprise a 3×4 projection matrix including intrinsic parameters and extrinsic parameters for the sensor. For each iteration of the optimization process, a different set of candidate calibration parameters may be applied as discussed herein, and the optimization process may iteratively refine the set of candidate calibration parameters applied until a metric indicative of similarity (e.g., intersection over union) for the set of calibration parameters satisfies a threshold and/or converges.

The sampled bounding shapes and the set of candidate calibration parameters may be used to generate candidate bounding shapes that may be used to evaluate the accuracy of the set of candidate calibration parameters. The center points of the sampled bounding shapes may be determined (or used if the preprocessing included this determination), and 3D locations of the center points of the sampled bounding shapes may be determined using a homography matrix based on the set of candidate calibration parameters. A 3D model of the object corresponding to a sampled bounding shape may then be placed or formed with the center point of the sampled bounding shape being the center point of the 3D model. The 3D model may be a cylinder or other shape that models the object (e.g., a standing person). The 3D model used for each object of the same type may have the same size and dimensions or respective 3D models may be used for the respective objects that have a size and dimension that is specific to the respective object. Once the 3D models of the objects corresponding to the sampled bounding shapes are placed or formed, the 3D models of the objects may be projected from a 3D position to a 2D position in the image plane using the set of candidate calibration parameters. The candidate bounding shapes are determined based on the 2D position of the projected models of the objects corresponding to the sampled bounding shapes in the image plane. For example, the respective candidate bounding shapes may be determined to have dimensions that contain the entire respective projected model corresponding to the sampled bounding shape. The candidate bounding shapes generated are essentially an estimation of what the sampled bounding shapes would look like in the 2D image if the set of candidate calibration parameters was correct.

The candidate bounding shapes may be compared to the sampled bounding shapes in order to determine a difference between them. In some embodiments, the difference between the candidate bounding shape and its corresponding sampled bounding shape may be based on intersection over union determination. For a total evaluation of the quality of the estimate of the set of candidate calibration parameters, an average of all of the difference determinations (e.g., intersection over union determinations) may be determined to produce an overall similarity metric that is indicative of a similarity between the candidate bounding shapes and the sampled bounding shapes. If the difference (or similarity metric) does not satisfy a threshold and/or level of convergence, a new set of candidate calibration parameters may be selected, and the process may be repeated with the new set of candidate calibration parameters. The proximity of the new set of candidate calibration parameters to the previous iteration may depend on the similarity metric and whether the previous iteration was an improvement over prior iterations. For example, the new set of candidate calibration parameters may be selected to be relatively close to the previous iteration in the calibration parameter space if the previous iteration was an improvement over prior iterations.

In response to the similarity metric satisfying a threshold and/or level of convergence, the set of estimated calibration parameters may be output and used for calibration of the sensor. The threshold and/or the level of convergence may be selected, for example, based on requirements for the sensor (e.g., accuracy), time available for the calibration process, and other factors. The 3D models and/or the candidate bounding shapes generated using the output set of estimated calibration parameters may also be projected onto images with or without the similarity metric associated with the set of candidate calibration parameters.

To enhance the rotation parameter estimation, a vanishing point metric may be considered during the optimization process in addition to the similarity metric discussed above. The vanishing point metric may be determined based on a distance (e.g., a Euclidean distance) between the vanishing point of vertical lines in the scene of the 2D images and the vanishing point of projected candidate bounding shapes (e.g., corresponding to the set of estimated calibration parameters). The optimization process may select a new set of candidate calibration parameters (e.g., rotation parameters) to reduce the distance between the vanishing points in addition to the factors discussed above.

In some embodiments, pose estimates for the objects detected in the 2D images may also be determined and utilized as part of the optimization process. The pose estimates may be determined using one or more pose estimate models that may depend on the type of object. For example, if the objects identified in the images are people, then a body pose estimate may be determined using one or more body pose estimate models (e.g., PoseNet). The pose estimates may be associated with detection bounding shapes and used to filter or remove detection bounding shapes that are outliers. For example, detection bounding shapes may be removed if the estimated pose corresponding to that detection bounding shape indicates an abnormal pose (e.g., seated, occluded, etc.). The pose estimate corresponding to a sampled bounding shape may also be used when generating the 3D model of the object corresponding to that sampled bounding shape, which may produce more accurate 3D models and results for the optimization process.

In some embodiments, lens distortion parameters may be estimated prior to the optimization process discussed herein for determining calibration parameters for the sensor. The lens distortion parameters may be used to rectify the 2D images captured by the sensor, which may enhance the accuracy of the estimation of the calibration parameters. A lens distortion parameter space (e.g., defined by the range of each lens distortion parameter) may be searched for a set of lens distortion parameters for the sensor using another optimization process that attempts to match points of line segments and fitting lines for those line segments. Line segments in the 2D images may be detected using one or more line detection models and fitting lines may be determined for points of the detected line segments. The optimization process may iteratively refine candidate lens distortion parameters that are applied to attempt to reduce a number of lines and/or an average distance between points of line segments and fitting lines for those line segments. The optimization process may continue to refine the candidate lens distortion parameters until the number of lines and/or the distance between points of line segments and fitting lines for those line segments converges.

Embodiments presented in this disclosure may be implemented in the context of sensor calibration in large spaces, such as, but not limited to, warehouses, factories, retail stores, outdoor spaces, and/or other locations. However, it should be understood that other embodiments may include determining calibration parameters for other types of sensors, such as sensors on vehicles such as, but not limited to, non-autonomous vehicles, semi-autonomous vehicles, piloted and un-piloted robots or robotic platforms, warehouse vehicles, off-road vehicles, vehicles coupled to one or more trailers, aircraft, spacecraft, boats, shuttles, emergency response vehicles, construction vehicles, underwater craft, drones, and/or other vehicle types.

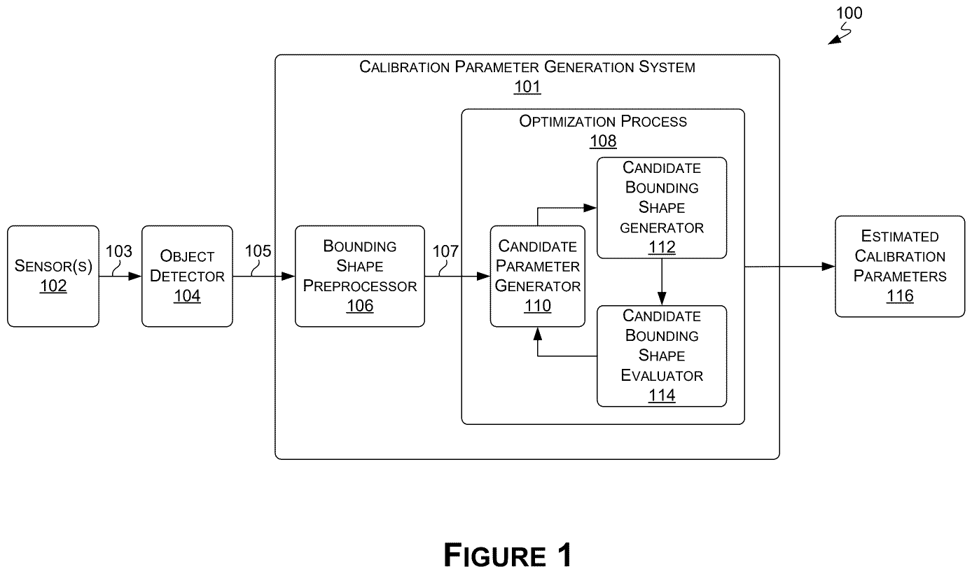

With reference to FIG. 1, FIG. 1 is an example data flow diagram illustrating the interconnection of components and flow of information or data for sensor calibration parameter generation, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in FIG. 1, the process 100 may include a calibration parameter generation system 101 that generates estimated calibration parameters 116 for one or more sensors 102 using an optimization process 108. The estimated calibration parameters 116 for the sensor(s) 102 generated by the calibration parameter generation system 101 may include external calibration parameters such as, for example, rotation and translation (also referred to as roll and tilt) and/or other parameters. The estimated calibration parameters 116 for the sensor(s) 102 may include internal calibration parameters for the sensor(s) 102 such as, for example, optical center (also known as the principal point), focal length, skew coefficient, field of view or sensory field, and/or other parameters. In some embodiments, the estimated calibration parameters 116 for the sensor(s) 102 may comprise a 3×4 projection matrix including intrinsic parameters and extrinsic parameters for the sensor(s) 102.

As illustrated in FIG. 1, in some embodiments, the calibration parameter generation system 101 may include a bounding shape preprocessor 106 and implement an optimization process 108 using a candidate parameter generator 110, a candidate bounding shape generator 112, and a candidate bounding shape evaluator 114. The calibration parameter generation system 101 may generate and output respective estimated calibration parameters 116 for the respective sensor(s) 102 using the techniques described herein.

The sensor(s) 102 may be positioned in an environment such as, for example, large spaces (e.g., warehouses, factories, retail stores, etc.) or outdoor spaces. The sensor(s) 102 may capture sensor data 103 (e.g., corresponding or representing one or more images) that includes one or more objects. The sensor(s) 102 may include, without limitation, any type of optical sensor (e.g., RGB optical sensor(s), IR optical sensor(s), RGB-IR optical sensor(s), depth sensor(s), camera(s), and/or other optical sensor(s) such as but not limited to those described herein—such as security and surveillance systems, environment simulation systems, etc., in some examples). The sensor data 103 may include, without limitation, sensor data from any type of optical sensor(s) used for the sensor(s) 102. In some embodiments, the sensor data 103 may correspond to 2D images or 2D image frames generated from the sensor data 103 captured using one or more in-building sensors or outdoor sensors.

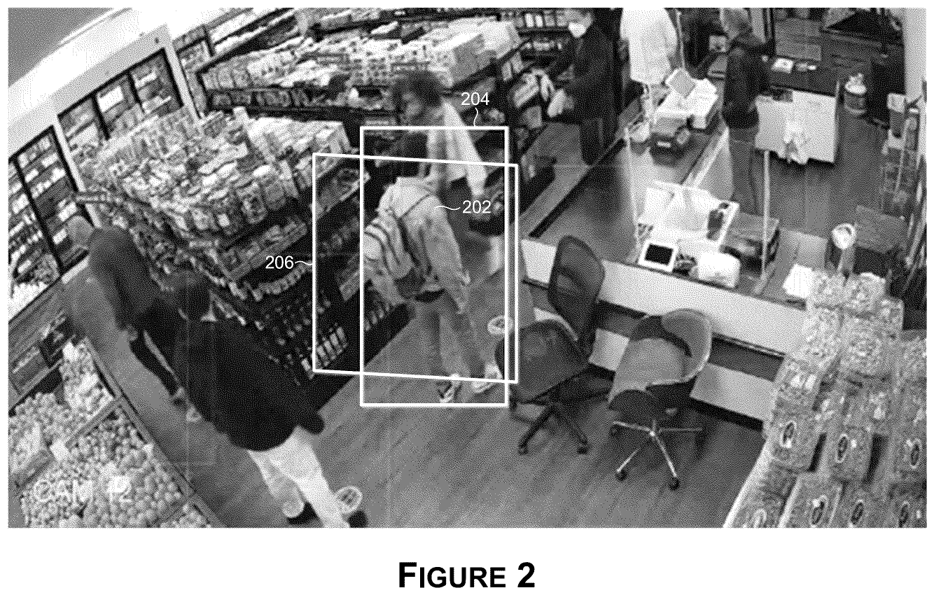

The sensor data 103 may be provided to an object detector 104, which may implement one or more object detection models (e.g., PeopleNet, SyntheticaDETR, etc.) that detect one or more objects (e.g., humans, vehicles, robots, etc.) in the sensor data 103. The object detector 104 further generates detection bounding shapes 105 that correspond to objects detected in the sensor data 103 (e.g., detection bounding shapes 204 as discussed herein with respect to FIG. 2). The detection bounding shapes 105 may identify and localize one or more objects in the sensor data 103. In some embodiments, the detection bounding shapes 105 are detection bounding boxes and may serve as ground truth data for the calibration parameter generation system 101 described herein. The detection bounding shapes for the 2D images may correspond to a single object that is detected in multiple images or multiple objects that are detected in one or more images. The object detector 104 may output the detection bounding shapes 105 for further processing via the calibration parameter generation system 101.

The bounding shape preprocessor 106 may receive the detection bounding shapes 105 from the object detector 104 and establish a dataset of sampled bounding shapes 107 from the detection bounding shapes 105. In some embodiments, the dataset of sampled bounding shapes 107 may include multiple detection bounding shapes from one or more 2D images. Detection bounding shapes may be generated for multiple 2D images, and the detection bounding shapes for these 2D images may be accumulated into a single image or single image frame. For example, if sensor data 103 for two images is captured by the sensor 102 and the object detector 104 generates two detection bounding shapes for the sensor data 103 representing each of the images, then the single image or image frame would include four detection bounding shapes after accumulating the detection bounding shapes.

In some embodiments, the bounding shape preprocessor 106 may remove detection bounding shapes that may bias the calibration parameter estimation. The bounding shape preprocessor 106 may perform one or more preprocessing techniques for the detection bounding shapes prior to accumulation of images (e.g., on an image-by-image basis) or after accumulation of images. The preprocessing techniques may be used to remove detection bounding shapes from further use and/or to select particular detection bounding shapes to be used in the optimization process described herein.

The bounding shape preprocessor 106 may remove detection bounding shapes that touch/intersect with an outer boundary/border of the image or image frame. In some embodiments, the bounding shape preprocessor 106 may fit a characteristic (e.g., height, width, aspect ratio) of the detection bounding shapes to a curve (e.g., polynomial curve) and remove detection bounding shapes that are more than a threshold distance from the curve (e.g., outliers). For example, separate curves may be used for fitting height, width, and aspect ratio, and a detection bounding shape may be removed if its height, width, or aspect ratio are more than a threshold distance away from the respective curves.

The bounding shape preprocessor 106 may divide the image (or images, if applicable) into regions, which may form a grid, and assign each of the detection bounding shapes to a respective region. In some embodiments, the detection bounding shapes may be assigned to a region based on a center point or center coordinate of the detection bounding shape. Once the detection bounding shapes are assigned to a region, the bounding shape preprocessor 106 may remove all but one of the detection bounding shapes for each region (that includes any detection bounding shapes) such that a single detection bounding shape remains per region. The selection of the particular detection bounding shapes may be determined, for example, based on the detection bounding shape that has a median size for the region. The detection bounding shapes that are selected may form the dataset of the sampled bounding shapes 107 output by the bounding shape preprocessor 106. In some embodiments, the bounding shape preprocessor 106 may be omitted from the calibration parameter generation system 101, and the dataset of sampled bounding shapes 107 includes all of the detection bounding shapes 105 generated by the object detector 104.

Based at least on the dataset of the sampled bounding shapes 107, the calibration parameter generation system 101 may search a parameter space for the estimated calibration parameters 116 for the sensor 102 using an optimization process 108. The optimization process 108 may be implemented, for example, as a Bayesian or black-box optimization process. For each iteration of the optimization process 108, a different set of candidate calibration parameters may be generated by the candidate parameter generator 110, and the optimization process 108 may include iterative refinement of the candidate calibration parameters until the evaluation by the candidate bounding shape evaluator 114 indicates that a metric indicative of similarity (e.g., intersection over union) for the candidate calibration parameters satisfies a threshold and/or level of convergence (e.g., the metric indicative of similarity for different iterations of the optimization process converges).

For the first iteration of the optimization process 108, the candidate parameter generator 110 may generate initial candidate calibration parameters for the sensor(s) 102 based on a defined calibration parameter space. The initial candidate calibration parameters may be randomly selected from within the defined calibration parameter space using additional context, past data, or the like to increase the likelihood that the initial candidate calibration parameters will be closer to the estimated calibration parameters 116 output by the calibration parameter generation system 101 and provide a better starting point.

The candidate bounding shape generator 112 may generate candidate bounding shapes based on the dataset of sampled bounding shapes 107 and the set of candidate calibration parameters generated by the candidate parameter generator 110. The candidate bounding shape generator 112 may determine the center points of the sampled bounding shapes (or use them if the bounding shape preprocessor 106 performed this determination), and the candidate bounding shape generator 112 may determine 3D locations of the determined center points using a homography matrix based on the set of candidate calibration parameters. The candidate bounding shape generator 112 may place or form a 3D model of the object corresponding to a sampled bounding shape with the center point of the sampled bounding shape being the center point of the 3D model. The 3D model may be a cylinder or other shape that models the object (e.g., a standing person). The 3D model used for each object of the same type may have the same size and dimensions or respective 3D models may be used for the respective objects that have a size and dimension that is specific to the respective object. In some embodiments, the size and dimension of a 3D model that is specific to a respective object may be determined based on a pose estimate for the respective object in a corresponding image.

Once the 3D models of the objects corresponding to the sampled bounding shapes are placed or formed, the candidate bounding shape generator 112 may project the 3D models of the objects from a 3D position to a 2D position in the image using the set of candidate calibration parameters. The candidate bounding shape generator 112 determines the candidate bounding shapes based on the 2D position of the projected models of the objects corresponding to the sampled bounding shapes in the image plane. For example, the respective candidate bounding shapes may be determined to have dimensions that contain the entire respective projected model corresponding to the sampled bounding shape. The candidate bounding shapes generated are essentially an estimation of what the sampled bounding shapes would look like in the 2D image if the set of candidate calibration parameters was correct.

The candidate bounding shape evaluator 114 may compare the candidate bounding shapes to the dataset of sampled bounding shapes 107 in order to determine a difference between them. In some embodiments, the difference between a candidate bounding shape and its corresponding sampled bounding shape may be based on intersection over union determination. For a total evaluation of the quality of the estimate of the set of candidate calibration parameters selected by the candidate parameter generator 110, an average of all of the difference determinations (e.g., intersection over union determinations) may be determined to produce an overall similarity metric that is indicative of a similarity between the candidate bounding shapes and the dataset of sampled bounding shapes 107.

If the difference (or similarity metric) does not satisfy a threshold and/or level of convergence, a new set of candidate calibration parameters may be selected by the candidate parameter generator 110 based on the previous set of candidate calibration parameter(s). The proximity of the new set of candidate calibration parameters selected by the candidate parameter generator 110 to the previous iteration may depend on the difference or similarity metric and whether the previous iteration was an improvement over prior iterations. For example, the new set of candidate calibration parameters may be selected by the candidate parameter generator 110 to be relatively close to the previous iteration in the calibration parameter space if the previous iteration was an improvement over prior iterations. The process of generating the candidate bounding shapes using the candidate bounding shape generator 112 and the evaluation of the candidate bounding shapes using the candidate bounding shape evaluator 114 may be repeated based on the new set of candidate calibration parameters.

In response to the metric indicative of similarity for the candidate calibration parameters satisfying a threshold and/or a level of convergence, the calibration parameter generation system 101 may output the estimated calibration parameters 116. The estimated calibration parameters 116 may be used for calibration of the sensor 102. The threshold and/or the level of convergence may be selected, for example, based on requirements for the sensor 102 (e.g., accuracy), time available for the calibration process, and other factors. The calibration parameter generation system 101 may also output the candidate bounding shapes generated by the candidate bounding shape generator 112. For example, the calibration parameter generation system 101 may output the candidate bounding shapes for one or more objects projected on one or more images. In some embodiments, the estimated calibration parameters 116 and/or the candidate bounding shapes may be provided to a user for verification, if desired. The estimated calibration parameters 116 may be applied to sensor data 103 (e.g., image data) from the sensor 102 (e.g., a camera) to, for example, enable 3D location, depth, and/or pose estimation for objects (e.g., a person) in an environment monitored with the sensor 102. The estimated calibration parameters 116 may also be applied to sensor data 103 (e.g., image data) from the sensor 102 (e.g., a camera) for other applications, which may include but are not limited to, object tracking, augmented reality, camera localization, etc.

Now referring to FIG. 2, FIG. 2 is an example image 200 that may be generated from sensor data captured by a sensor (e.g., sensor 102). The image 200 depicts a scene of a convenience store and a number of people that are in the convenience store. For explanation purposes, FIG. 2 focuses on a person 202 in the middle of the image 200 and includes a detection bounding shape 204 and a candidate bounding shape 206 that has been generated for the person 202 (e.g., by the candidate bounding shape generator 112) as part of the calibration parameter generation system 101 performing the optimization process 108. As shown in FIG. 2, the candidate bounding shape 206 overlaps with the detection bounding shape 204 to some extent, but the candidate bounding shape 206 is both wider and shorter than the detection bounding shape 204. Depending on the threshold set for the optimization process 108, the calibration parameter generation system 101 may output the candidate calibration parameters associated with the candidate bounding shape 206 as the estimated calibration parameters 116 or may perform another iteration of the optimization process 108.

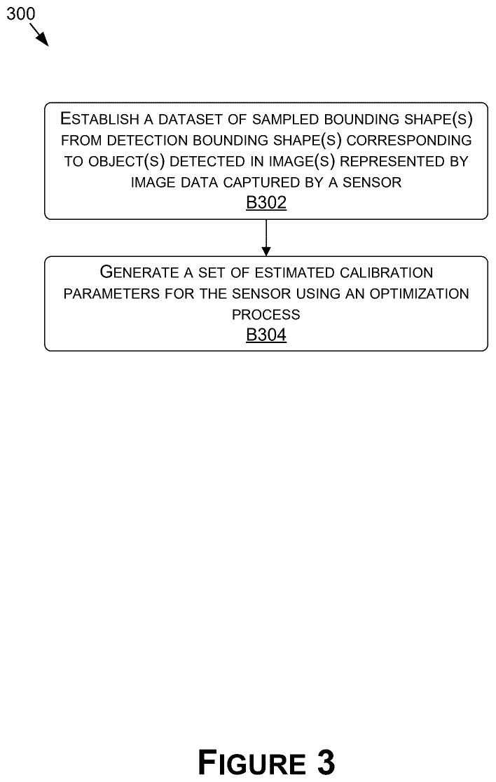

Now referring to FIG. 3, FIG. 3 is a flow diagram showing an example method 300 for sensor calibration parameter generation, in accordance with some embodiments of the present disclosure. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

The method 300, at block B302, includes establishing a dataset of one or more sampled bounding shapes from one or more detection bounding shapes corresponding to one or more objects detected in one or more images represented by sensor data captured by a sensor (e.g., sensor data 103 captured by the sensor 102). In some embodiments, at least some detection bounding shapes may be removed (e.g., using the bounding shape preprocessor 106) that may otherwise bias the calibration parameter estimation in order to establish the dataset of one or more sampled bounding shapes. The removal may occur prior to accumulation of images (e.g., on an image-by-image basis) or after accumulation of images.

The method 300, at block B304, includes generating a set of estimated calibration parameters for the sensor using an optimization process. The set of estimated calibration parameters may be generated based on the dataset of one or more sampled bounding shapes remaining after the preprocessing (e.g., using the bounding shape preprocessor 106) described herein. The optimization process (e.g., using the candidate parameter generator 110) may include iteratively starting with an initial guess for the candidate calibration parameters and then refining the candidate calibration parameters applied until a metric indicative of similarity (e.g., intersection over union) for the set of calibration parameters satisfies a threshold and/or converges.

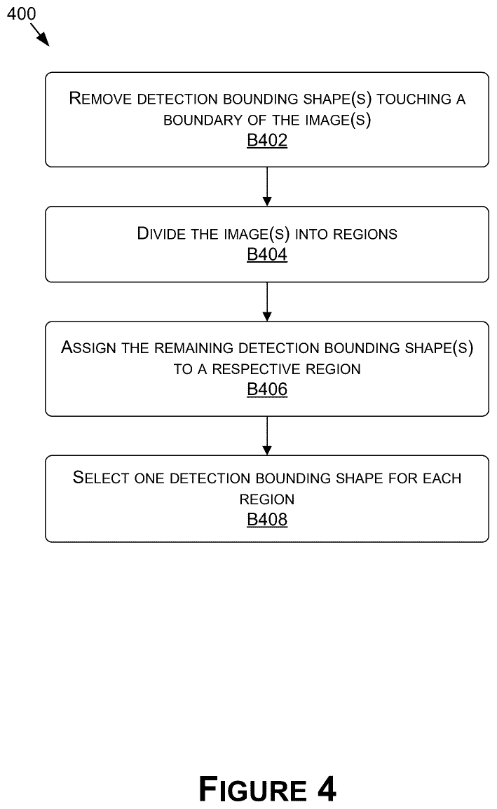

Now referring to FIG. 4, FIG. 4 is a flow diagram showing an example method 400 for establishing a dataset of sampled bounding shapes, in accordance with some embodiments of the present disclosure. Each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

The method 400, at block B402, includes removing one or more detection bounding shapes touching a boundary of one or more images. The boundary of an image may correspond to the edges or limits that define the extent of image data representing the image. In some embodiments, the boundary of the image may be defined as part of an image frame. For example, the boundary may correspond to the outermost columns and rows of pixels on the sides of the image.

The method 400, at block B404, includes dividing the one or more images into regions. The size and shape of the regions may be selectable. The particular regions may be square, rectangular, or another shape that may be used to divide the one or more images. In some embodiments, the regions may form a grid.

The method 400, at block B406, includes assigning the remaining one or more detection bounding shapes to a respective region. In some embodiments, center points/coordinates of the detection bounding shapes may be determined (e.g., using the bounding shape preprocessor 106), and the center points/coordinates may be used to assign the detection bounding shapes to the particular region that contains the center point/coordinates.

The method 400, at block B408, includes selecting one detection bounding shape for each region. One or more regions may not have a detection bounding shape assigned to them at block B406, and no detection bounding shapes are selected for those region(s) for block B408. For the regions that have one detection bounding shape assigned to the region, that single detection bounding shape may be selected. For the regions that have multiple detection bounding shapes assigned to them, one of the detection bounding shapes may be selected as part of the sampled bounding shapes (e.g., the dataset of sampled bounding shapes 107) that are provided to the calibration parameter generation system 101. In other words, all but one of the detection bounding shapes for each region (that includes any detection bounding shapes) may be removed such that one detection bounding shape remains per region. The selection of the particular detection bounding shapes may be determined, for example, based on the detection bounding shape that has a median size for the region.

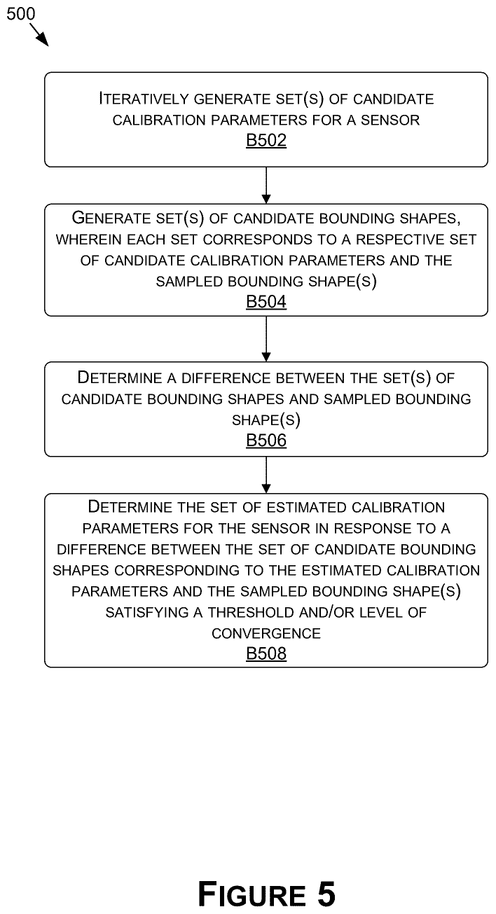

Now referring to FIG. 5, FIG. 5 is a flow diagram showing an example method 500 for generating calibration parameters for a sensor, in accordance with some embodiments of the present disclosure. Each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIG. 1. However, this method may additionally or alternatively be executed by any one system, or any combination of systems, including, but not limited to, those described herein.

The method 500, at block B502, includes iteratively generating one or more sets of candidate calibration parameters for a sensor. For the first iteration, the candidate parameter generator 110 may generate initial candidate calibration parameters for the sensor (e.g., sensor 102) based on a defined calibration parameter space. The initial candidate calibration parameters may be randomly selected or may be selected from within the defined calibration parameter space using additional context, past data, or the like to potentially provide a better starting point.

The method 500, at block B504, includes generating one or more sets of candidate bounding shapes. Each set of candidate bounding shapes corresponds to a respective set of candidate calibration parameters and the one or more sampled bounding shapes. The candidate bounding shape generator 112 may generate the one or more sets of candidate bounding shapes based on the dataset of sampled bounding shapes 107 and the set of candidate calibration parameters generated by the candidate parameter generator 110. In some embodiments, the candidate bounding shape generator 112 may project the 3D models of the objects (e.g., generic 3D models for a type of object and/or individualized 3D models for a particular object) from a 3D position to a 2D position in the image plane using the set of candidate calibration parameters and generate candidate bounding shapes that encompass the projections. The respective candidate bounding shapes may be determined to have dimensions that contain the entire respective projected model corresponding to the sampled bounding shape.

The method 500, at block B506, includes determining a difference between the one or more sets of candidate bounding shapes and the one or more sampled bounding shapes. The candidate bounding shape evaluator 114 may determine differences between candidate bounding shapes and corresponding sampled bounding shapes (e.g., based on an intersection over union determination). For a total evaluation of the quality of the estimate of the set of candidate calibration parameters selected by the candidate parameter generator 110, an average of all of the difference determinations (e.g., intersection over union determinations) may be determined to produce an overall similarity metric that is indicative of a similarity between the candidate bounding shapes and the sampled bounding shapes.

The method 500, at block B508, includes determining the set of estimated calibration parameters for the sensor in response to a difference between the set of candidate bounding shapes corresponding to the estimated calibration parameters and the one or more sampled bounding shapes satisfying a threshold and/or a level of convergence. In some embodiments, in response to the difference(s) (or metric indicative of similarity) corresponding the candidate calibration parameters satisfying a threshold and/or a level of convergence, the calibration parameter generation system 101 may determine and output the estimated calibration parameters 116. The estimated calibration parameters 116 may be used for calibration of the sensor 102. The threshold and/or the level of convergence may be selected, for example, based on requirements for the sensor 102 (e.g., accuracy), time available for the calibration process, and other factors.

If the difference(s) (or metric indicative of similarity) corresponding to the candidate calibration parameters does not satisfy the threshold or level of convergence, the candidate parameter generator 110 may select a new set of candidate calibration parameters based on the previous set of candidate calibration parameter(s). The proximity of the newly selected set of candidate calibration parameters to the previous iteration may depend on the difference(s) (or similarity metric) and whether the previous iteration was an improvement over prior iterations. For example, the new set of candidate calibration parameters may be selected to be relatively close to the previous iteration in the calibration parameter space if the previous iteration was an improvement over prior iterations. The process of generating the candidate bounding shapes using the candidate bounding shape generator 112 and the evaluation of the candidate bounding shapes using the candidate bounding shape evaluator 114 may be repeated based on the new set of candidate calibration parameters.

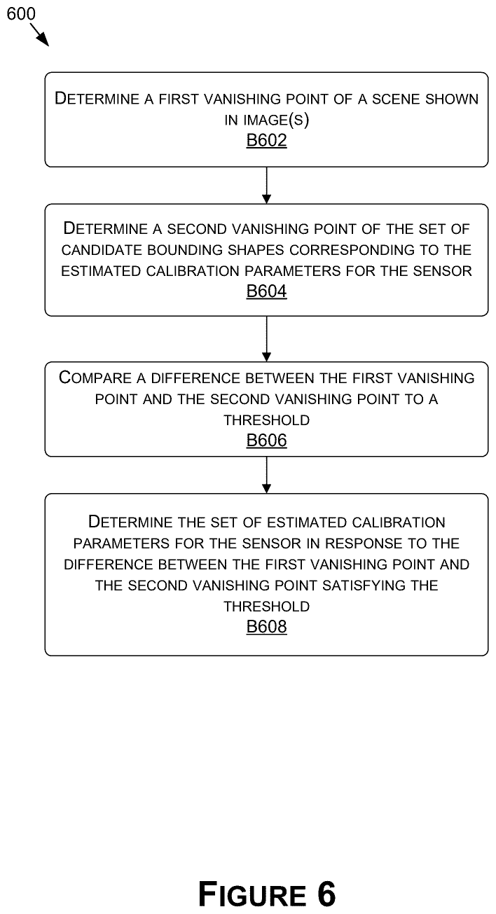

Now referring to FIG. 6, FIG. 6 is a flow diagram showing an example method 600 for sensor calibration parameter generation, in accordance with some embodiments of the present disclosure. Each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIG. 1. However, this method may additionally or alternatively be executed by any one system, or any combination of systems, including, but not limited to, those described herein.

The method 600, at block B602, includes determining a first vanishing point of vertical lines of a scene shown in one or more images. Depending on the orientation of the sensor (e.g., sensor 102), the first vanishing point of the scene may be located within the boundary of the image or outside of the boundary of the image. When the first vanishing point is located outside of the image, it may correspond to a point where the vertical lines from the scene shown in the image would meet if extended outside the boundary of the image. When the first vanishing point is located within image, it may correspond to a point where the vertical lines meet in the scene shown in the image or where the vertical lines from the scene shown in the image would meet if extended within the image. The first vanishing point may be represented by 2D coordinates (e.g., in the image coordinate system).

The method 600, at block B604, includes determining a second vanishing point of the set of candidate bounding shapes corresponding to the estimated calibration parameters for the sensor. Depending on the orientation of the sensor (e.g., sensor 102), the second vanishing point of the scene may also be located within the boundary of the image or outside of the boundary of the image. When the second vanishing point is located outside of the image, it may correspond to a point where the lines extending through the candidate bounding shapes (e.g., through the center of the candidate bounding shapes toward the ground) projected onto the image would meet if extended outside the boundary of the image. When the second vanishing point is located within image, it may correspond to a point where the vertical lines meet in the scene shown in the image or where the lines extending through the candidate bounding shapes would meet if extended within the image. The second vanishing point may be represented by 2D coordinates (e.g., in the image coordinate system).

The method 600, at block B606, includes comparing a difference between the first vanishing point and the second vanishing point to a threshold. The difference between the first vanishing point and the second vanishing point may be a distance between the first vanishing point and the second vanishing point (e.g., a Euclidean distance). The threshold may be selected, for example, based on requirements for the sensor (e.g., accuracy), time available for the calibration process, and other factors. In some embodiments, a score (e.g., between 0 and 1) indicative of the vanishing point difference between the first vanishing point and the second vanishing point may be generated. For example, a relatively small distance between the vanishing points may be closer to 1 and a relatively large distance between the vanishing points may be closer to 0.

The method 600, at block B608, includes determining the set of estimated calibration parameters for the sensor (for example, as described with respect to block B508) in response to the difference between the first vanishing point and the second vanishing point satisfying the threshold. The calibration parameter generation system 101 may verify the difference between the first vanishing point and the second vanishing point satisfies the threshold prior to outputting the set of estimated calibration parameters as another verification step to ensure the suitability of the estimated calibration parameters 116. In some embodiments, the calibration parameter generation system 101 may use a combined score that includes the metric indicative of similarity (e.g., average intersection over union) and the score indicative of the vanishing point difference with respective weighting to determine whether to output the estimated calibration parameters. For example, the calibration parameter generation system 101 may output the estimated calibration parameters 116 if the combined score is above a combined score threshold. This combined score threshold may be selected, for example, based on requirements for the sensor (e.g., accuracy), time available for the calibration process, and other factors.

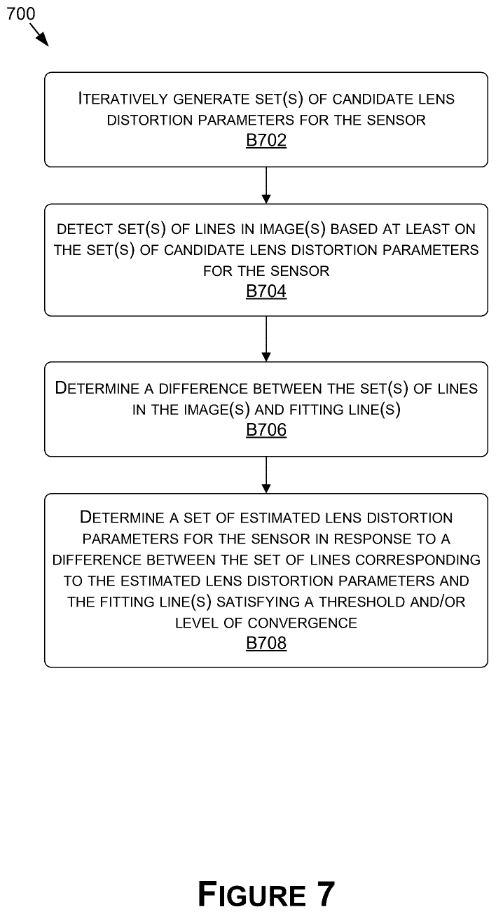

Now referring to FIG. 7, FIG. 7 is a flow diagram showing an example method 700 for lens distortion calibration parameter generation, in accordance with some embodiments of the present disclosure. Each block of method 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the system of FIG. 1. However, this method may additionally or alternatively be executed by any one system, or any combination of systems, including, but not limited to, those described herein.

In some embodiments, the method 700 may be performed prior to, for example, the object detection and the sensor calibration process described herein in order to generate rectified images for use during the object detection and calibration, which may lead to generation of more accurate estimated calibration parameters for a sensor (e.g., sensor 102).

The method 700, at block B702, includes iteratively generating one or more sets of candidate lens distortion parameters for the sensor. The sets of candidate lens distortion parameters for the sensor may be generated using a second optimization process. For the first iteration of the second optimization process, initial lens distortion parameters for the sensor 102 may be generated based on a defined lens distortion parameter space. The initial lens distortion parameters may be randomly selected. In some embodiments, the initial lens distortion parameters may be selected from within the defined lens distortion parameter space using additional context, past data, or the like to increase the likelihood that the initial lens distortion parameters will be closer to the estimated lens distortion output by the second optimization process and provide a better starting point.

The method 700, at block B704, includes detecting one or more sets of lines in one or more images based at least on the one or more sets of candidate lens distortion parameters for the sensor. One or more detection models may be used to detect the sets of lines in the one or more images based on the candidate lens distortion parameters. In some embodiments, multiple segments of a line in the one or more images may be detected using a 3D Hough space.

The method 700, at block B706, includes determining a difference between the sets of lines in the one or more images and one or more fitting lines. One or more models may be used to generate fitting lines (e.g., straight fitting lines) to points of the sets of lines detected at block B704 and a difference (e.g., distance) between points of the detected lines and the generated fitting lines may be determined. For a total evaluation of the quality of the estimate of the set of candidate lens distortion parameters selected, an average of all of the difference determinations may be determined to produce an overall similarity metric that is indicative of a similarity between the detected lines and the fitting lines.

The method 700, at block B708, includes determining a set of estimated lens distortion parameters for the sensor in response to a difference between the set of lines corresponding to the estimated lens distortion parameters and the one or more fitting lines satisfying a threshold and/or a level of convergence. In some embodiments, in response to the metric indicative of similarity for the candidate lens distortion parameters satisfying a threshold and/or a level of convergence, the estimated lens distortion parameters may be output. The estimated lens distortion parameters may be used to rectify images represented by the sensor data 103 captured by the sensor 102. The threshold and/or the level of convergence may be selected, for example, based on requirements for the sensor 102 (e.g., accuracy), time available for the lens distortion determination process or calibration process, and other factors.

If the metric indicative of similarity for the candidate lens distortion parameters does not satisfy the threshold or level of convergence, a new set of candidate lens distortion parameters may be selected based on the previous set of candidate lens distortion parameter(s). The proximity of the newly selected set of candidate lens distortion parameters to the previous iteration may depend on the difference and whether the previous iteration was an improvement over prior iterations. For example, the new set of candidate lens distortion parameters may be selected to be relatively close to the previous iteration in the lens distortion parameter space if the previous iteration was an improvement over prior iterations. The process of detecting the lines and determining differences between the detected lines and fitting lines may be repeated based on the new set of candidate lens distortion parameters.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated measurements and/or sensor data may be used that includes the application of realistic sensor calibration data generated within the simulation environment, and may use this information to perform operations (e.g., validation, calibration, etc.) associated with the virtual machine within the environment. These simulated operations may be used to test performance of the underlying algorithms, systems, and/or processes prior to deploying them in the real world. In some instances, the simulation may be used to generate synthetic calibration data—e.g., calibration data including objects of interest from within the simulation. The synthetic calibration data (in addition to or alternatively from real-world data) may then be processed to calibrate a sensor for security, surveillance, and/or other applications, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), one or more vision language models (VLMs), multi-modal language models, (MMLMs), systems for performing light transport simulation, systems for performing collaborative content creation for 3D assets, systems implemented at least partially using cloud computing resources, and/or other types of systems.

### Example Computing Device

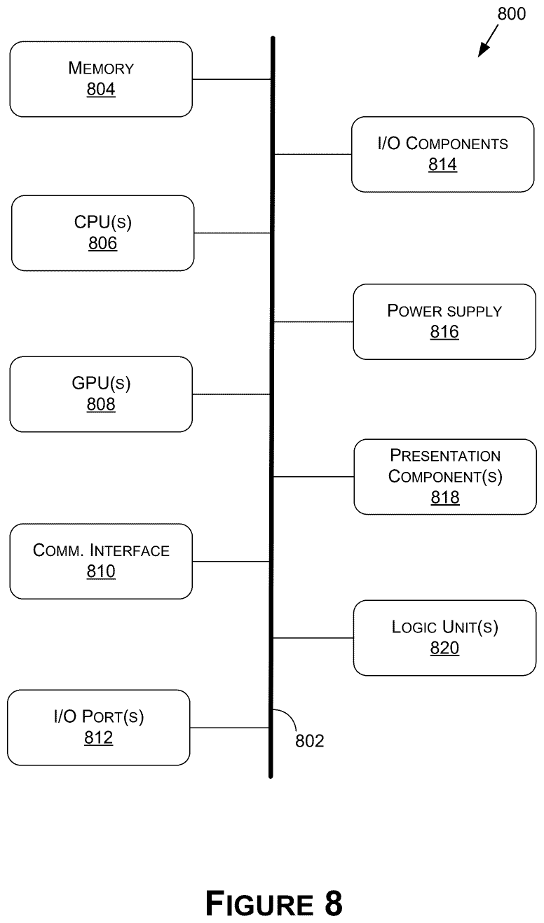

FIG. 8 is a block diagram of an example computing device(s) 800 suitable for use in implementing some embodiments of the present disclosure. In some embodiments, one or more functions of the calibration parameter generation system 101 described herein may be performed using the computing device 800. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the calibration parameter generation system 101 described herein may be executed, at least in part, by the CPU(s) 806 and/or GPU(s) 808.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808. In some embodiments, one or more functions of the calibration parameter generation system 101 described herein may be executed, at least in part, by the logic unit(s) 820.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality. In some embodiments, the computing device 800 may include the sensor(s) 102 and/or other sensors used in conjunction with the calibration parameter generation system 101 described herein.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.). In some embodiments, one or more sets of candidate bounding shapes (e.g., corresponding to the set of estimated calibration parameters output from the optimization process) may be projected onto image(s) and displayed, for example, using the presentation component(s) 818.

### Example Data Center

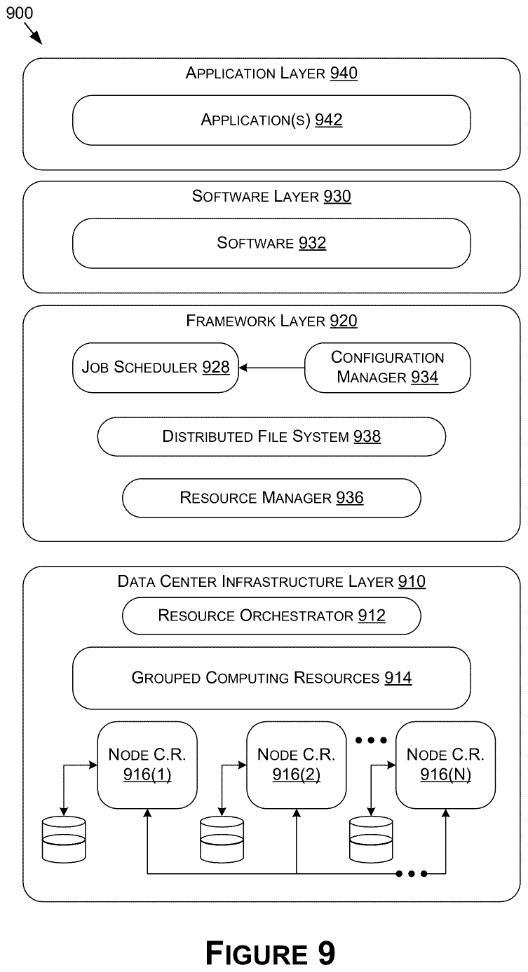

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM). In some embodiments, one or more functions of the calibration parameter generation system 101 described herein may be implemented, at least in part, using one or more of the node C.R.s 916(1)-9161(N).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resources 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a set of estimated calibration parameters for a sensor by:
iteratively generating one or more sets of candidate calibration parameters for the sensor;
generating one or more sets of candidate bounding shapes, wherein each set of the one or more sets of candidate bounding shapes corresponds to a respective set of the one or more sets of candidate calibration parameters and one or more sampled bounding shapes corresponding to one or more objects detected in one or more images, the one or more images representing sensor data captured by the sensor;
determining a difference between the one or more sets of candidate bounding shapes and the one or more sampled bounding shapes; and
determining the set of estimated calibration parameters for the sensor in response to a difference between a set of candidate bounding shapes corresponding to the set of estimated calibration parameters and the one or more sampled bounding shapes satisfying one or more of a first threshold or a level of convergence; and
cause the sensor to be calibrated using the set of estimated calibration parameters.

2. The one or more processors of claim 1, wherein the set of estimated calibration parameters comprises one or more of external calibration parameters for the sensor or internal calibration parameters for the sensor.

3. The one or more processors of claim 1, wherein at least one of: the one or more sampled bounding shapes or the one or more sets of candidate bounding shapes comprise bounding boxes.

4. The one or more processors of claim 1, wherein the processing circuitry is further to:
receive one or more pose estimates for the one or more objects detected in the one or more images; and
generate the one or more sets of candidate bounding shapes based at least on the one or more pose estimates for the one or more objects detected in the one or more images.

5. The one or more processors of claim 1, wherein the processing circuitry is to determine the one or more sampled bounding shapes from one or more detection bounding shapes by removing one or more detection bounding shapes that intersect with a boundary of one or more images, wherein the one or more detection bounding shapes correspond to one or more objects detected in the one or more images.

6. The one or more processors of claim 1, wherein the processing circuitry is to determine the one or more sampled bounding shapes from one or more detection bounding shapes using curve fitting, wherein the one or more detection bounding shapes correspond to one or more objects detected in the one or more images.

7. The one or more processors of claim 1, wherein the processing circuitry is to determine the one or more sampled bounding shapes from one or more detection bounding shapes corresponding to one or more objects detected in the one or more images by:
dividing the one or more images into a plurality of regions;
assigning the one or more detection bounding shapes to a respective region of the plurality of regions based at least on a center point of the one or more detection bounding shapes; and
removing all but one detection bounding shape per region for the one or more sampled bounding shapes.

8. The one or more processors of claim 1, wherein the processing circuitry is further to:
determine a first vanishing point of vertical lines of a scene shown in the one or more images;
determine a second vanishing point of the set of candidate bounding shapes corresponding to the set of estimated calibration parameters for the sensor; and
compare a difference between the first vanishing point and the second vanishing point to a second threshold;
wherein the processing circuitry is to determine the set of estimated calibration parameters based at least on whether the difference between the first vanishing point and the second vanishing point satisfies the second threshold.

9. The one or more processors of claim 1, wherein the processing circuitry is to generate the one or more sets of candidate bounding shapes based at least on a projection of one or more models of the one or more objects detected in the one or more images.

10. The one or more processors of claim 1, wherein the processing circuitry is further to generate estimated lens distortion parameters for the sensor by:
iteratively generating one or more sets of candidate lens distortion parameters for the sensor;
detecting one or more sets of lines in the one or more images based at least on the one or more sets of candidate lens distortion parameters for the sensor;
determining a difference between the one or more sets of lines in the one or more images and one or more fitting lines; and
determining the estimated lens distortion parameters for the sensor in response to a difference between a set of lines corresponding to the estimated lens distortion parameters and the one or more fitting lines satisfying one or more of a third threshold or a second level of convergence.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
iteratively generate one or more sets of candidate calibration parameters for a sensor based at least on a difference between one or more sets of candidate bounding shapes generated from the one or more sets of candidate calibration parameters and one or more sampled bounding shapes corresponding to one or more objects detected in one or more images, the one or more images representing sensor data captured by the sensor;
determine a set of estimated calibration parameters for the sensor in response to a difference between a set of candidate bounding shapes corresponding to the set of estimated calibration parameters for the sensor and the one or more sampled bounding shapes satisfying one or more of a first threshold or a level of convergence; and
cause the sensor to be calibrated using the set of estimated calibration parameters.

13. The system of claim 12, wherein the difference between the set of candidate bounding shapes corresponding to the set of estimated calibration parameters for the sensor and the one or more sampled bounding shapes is based at least on an intersection over union determination.

14. The system of claim 12, wherein the one or more objects comprise multiple objects, wherein the one or more images comprises multiple images.

15. The system of claim 12, wherein the one or more processors are to determine the one or more sampled bounding shapes from one or more detection bounding shapes corresponding to the one or more objects detected in the one or more images by:
removing detection bounding shapes touching a boundary of the one or more images;
dividing the one or more images into regions;
assigning respective detection bounding shapes to a respective region based at least on a center coordinate of the respective detection bounding shapes; and
selecting one detection bounding shape for each region.

16. The system of claim 12, wherein the one or more processors are to determine the one or more sampled bounding shapes from one or more detection bounding shapes corresponding to the one or more objects detected in the one or more images using curve fitting for one or more of a height, a width, or an aspect ratio of the one or more detection bounding shapes.

17. The system of claim 12, wherein the one or more processors are further to:
determine a first vanishing point of vertical lines of a scene shown in the one or more images;
determine a second vanishing point of the set of candidate bounding shapes corresponding to the set of estimated calibration parameters for the sensor; and
compare a difference between the first vanishing point and the second vanishing point to a second threshold;
wherein the one or more processors are to determine the set of estimated calibration parameters for the sensor based at least on whether the difference between the first vanishing point and the second vanishing point satisfies the second threshold.

18. The system of claim 12, wherein the one or more processors are further to generate the one or more sets of candidate bounding shapes based at least on one or more pose estimations for the one or more objects detected in the one or more images.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
generating calibration parameters for a sensor based at least on a difference between one or more candidate bounding shapes and one or more sampled bounding shapes corresponding to one or more objects detected in one or more images represented by sensor data captured by the sensor, wherein the one or more candidate bounding shapes are generated based at least on one or more sets of candidate calibration parameters and one or more projected models of the one or more objects detected in the one or more images represented by the sensor data captured by the sensor.
